(19) United States
(12) Patent Application Publication
(10) Pub. No.: US 2004/0217937 A1
(43) Pub. Date: Nov. 4, 2004

(54) Distributed PDA processing and method for computational operating continuity

(76) Inventors: Ray Moskalik, San Jose, CA (US); Chris Bradley, Redwood City, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/427,326

(22) Filed: May 1, 2003

(51) Int. Cl. G09G 5/00

(52) U.S. Cl. 345/156

(57) ABSTRACT

A method maintaining computational operating continuity irrespective of a user's location that allows a change in processing power to meet changing computational needs, comprising the steps of (a) providing a core operations system in a personal digital assistant, (b) manipulating the core operations system using the personal digital assistant when the user desires to perform computational tasks in physical locations where the use of a desktop computer is cumbersome, (c) alternatively coupling the personal digital assistant to a tablet display device augmenting processing power of the personal digital assistant for manipulating the core operations system when mobility is desired by the user and processing or display requirements exceed the capability of the personal digital assistant, and (d) alternatively coupling the personal digital assistant to a desktop display device to augment the processing power of the personal digital assistant for operation when mobility is unnecessary and processing or display requirements exceed the processing capability of the personal digital assistant. Display, tablet and desktop systems for implementing the method are also disclosed.

### BACKGROUND OF THE INVENTION

Personal computing has become an important aspect of many people's lives. With time the number of individuals that own or use computers has increased phenomenally. It has been estimated that 60% of American homes have at least one personal computer. In addition, a vast majority of businesses utilize computers extensively. As these machines become more intertwined in people's lives, there is a natural desire to be divorced of many of the physical limitations that have traditionally been inherent in computational processing. This desire has lead to the gradual decrease in size of personal computing devices in order to increase their portability. A significant link still exists, however, associating a given level of desired computational processing power and the locations where such a level of processing can occur. This association has influenced the design, manufacture and use of computing devices to a large extent.

For example, typically the nature of the machines designed to perform a given level of computational processing dictates the physical location at which processing can occur. A typical desktop computer cannot be easily transported because of its bulky size, weight, and continuous power requirements. In order to perform any computational task, the user is traditionally required to move to the physical location of the computer. The advantage of a desktop computer, however, is not being constrained by limited space and weight restrictions, thus allowing speed and efficiency to increase as technology increases independent of portability and convenience.

Laptop computers have been designed to overcome some of the limitations that are inherent in desktop computers. The size and weight of these devices are dramatically reduced, and they include rechargeable batteries to allow them to function for a time away from an AC power source. Many modern laptops function at a computational level that approaches that of most desktop computers, thus fulfilling some of the desire for increased portability without a significant change in potential computability. Even in this case, however, computational tasks are still linked to the physical location of the laptop. Most laptops cannot be conveniently used unless the user is sitting at a desk or table, and power requirements do not allow extended computing sessions away from an electrical outlet.

These limitations have lead to a desire for a computer that could be carried in a user's pocket. The Personal Digital Assistant (PDA) was developed for this purpose. The cell phone is now taking on a similar role of the PDA. This small computer was originally designed to handle very light computing functions, such as storing addresses and displaying text files. Because the computational level of these devices was low they had long battery lives, on the order of weeks. PDAs were later developed that could handle more computationally-intensive processing functions, however they were still unable to run full version desktop software applications. The inability to run these applications was not solely due to the decreased computational processing power of the PDA, but also its diminished graphics processing and screen size. Thus even for the PDA, the location still has a major impact on the level of computational processing due mainly to its increased portability.

In addition to these limitations, data that is shared between the PDA and the desktop must be periodically synchronized. The user must physically attach the PDA to a desktop or laptop computer to insure that the latest versions of a document or database are present on both machines. This process can be time consuming and especially troublesome if a user forgets to synchronize important data. In other words, despite advancements in technology, more powerful resources with PDA's, laptops and desktop computers, the operational modality of “location” based computers still appears to control system designs. The result is a continual need to make adjustments and synchronize memory databanks.

### SUMMARY OF THE INVENTION

One embodiment of the present invention provides a method for maintaining computational operating continuity irrespective of a user's location that allows a change in processing power to meet changing computational needs. The first step of the method is providing a core operations system in a personal digital assistant, cell phone or other mobile processor (PDA). In the second step of the method, the core operations system is manipulated using the PDA when the user desires to perform computational tasks in physical locations where the use of a desktop computer is cumbersome. In the third step of the method, the PDA is coupled to a tablet display device that augments the processing power of the PDA for manipulating the core operations system when mobility is desired and processing or display requirements exceed the capability of the PDA. In the fourth step of the method, the PDA is coupled to a desktop display device to augment the processing power of the PDA for manipulation of the core operations system when mobility is unnecessary and processing or display requirements exceed the processing capability of the PDA.

This method of computational operation represents a dramatic shift away from the traditional requirements imposed on computer users dictating specific location-dependent data processing. This design concept allows the user to be the center of continuous computer activity, without having to make adjustments while moving from one location to another. The user will now have the freedom and flexibility to engage in continuous computational processing spanning the range from absolute mobility to high demand data processing without the restrictions currently associated with both ends of the spectrum.

Another embodiment of the invention provides a display device to increase processing power of a personal digital assistant. The display device comprises a video display, a connector coupled to the video display configured for electronically coupling the personal digital assistant, and a processor within the video display configured for receiving output from the personal digital assistant and augmenting the output with greater processing capability.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a representative description of the steps comprising a method depicting an embodiment of the present invention;

FIG. 2 is a schematic view of the an embodiment of the invention;

FIG. 3 is a schematic view of yet another embodiment of the invention;

FIG. 4a is a perspective view of the back side of a tablet system embodiment;

FIG. 4b is a perspective view of the front side of a tablet system embodiment; and

FIG. 5 is a perspective view of a desktop system embodiment.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present inventors have observed that a major limitation on computational processing is the location-dependent nature of computers that is inherent in their design, requiring a user to move to the computer's physical location in order to process data. This limitation was unavoidable for many years because of size, weight, and power requirements. Technological advances have reduced these factors to allow greater portability, but this increased freedom has come at the cost of processing power. To address this issue, the inventors shifted from the traditional computer based perspective and have created an invention that allows the continuous use of a single core operations system in situations spanning the range from absolute mobility to highly demanding computational processing.

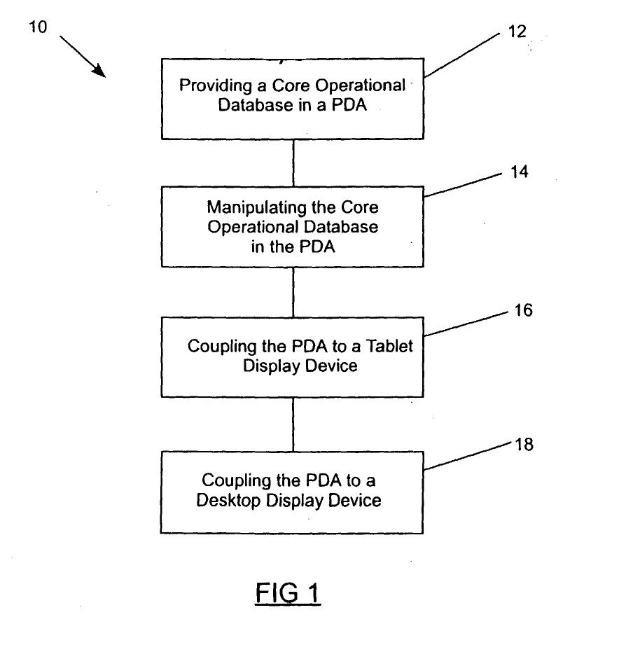

As shown in FIG. 1, the invention may be embodied as a method 10 for maintaining computational operating continuity irrespective of a user's location that allows a change in processing power to meet changing computational needs. Computational operating continuity refers to the ability to continually process data without the need for an interruption when changing to a device that allows higher or lower levels of processing power. In the first step of the method 12, a core operations system is provided in a personal digital assistant (PDA). A core operations system is any data, software, etc., that a user wishes to maintain. A PDA can be any of the set of small handheld computers, examples of which are the Palm devices, iPAQs, PocketPCs, and PDA/Cellular Phone combination devices. The PDA acts as a repository of the user's data, and thus can be carried wherever the user goes.

The second step 14 of the method is manipulating the core operations system using the PDA when the user desires to perform computational tasks in physical locations where the use of a desktop computer is cumbersome or inconvenient. Examples of this may include riding on a bus, lying on the grass in a park, or pacing back and forth across the floor in a hotel room. The small size of the PDA allows it to be slipped into the user's pocket to be taken virtually anywhere, and its low power consumption provides long functional durations without the need for frequent battery replacement or recharge. In the case of the PDA/Cellular Phone combination device, telecommunications data maintained in the core operations system is integrated with the telecommunications hardware, thus further increasing freedom and mobility.

In the third step 16 of the method, the PDA is coupled to a tablet display device, thus augmenting the processing power of the PDA for manipulating the core operations system when mobility is desired by the user and processing or display requirements exceed the capability of the PDA. The augmentation could be an additional central processing unit (CPU) and/or a graphics processing unit (GPU). When the PDA is coupled to the tablet display device, all of the data in the core operations system remains available to the user. The processing augmentation allows more complex computational tasks to be performed on the core operations system, the results of which can be displayed more efficiently and desirably on the tablet's larger screen due to the augmentation of the graphics processing ability of the PDA. When the PDA is uncoupled from the tablet display device, the core operations system is maintained with the user rather than on the tablet, thus eliminating the need for synchronization. This change in form factor occurs without a break in the continuity of the computational operation ability of the user. In other words, the user need not stop computing to make the switch to a device enable more processing power.

In the fourth step 18 of the method, the PDA is coupled to a desktop display device to augment the processing power of the PDA for operation when mobility is unnecessary and processing or display requirements exceed the processing capability of the PDA. The same points made above concerning augmentation and a lack of a need for synchronization applies to this step of the method. Similarly, this change in form factor to and from the desktop device occurs without a break in the continuity of the computational operational ability of the user.

This method of computational operation represents a dramatic shift away from the traditional requirements imposed on computer users dictating specific location-dependent data processing. The user will now have the freedom and flexibility to engage in continuous computational processing spanning the range from absolute mobility to high demand data processing without the restrictions currently associated with both ends of the spectrum.

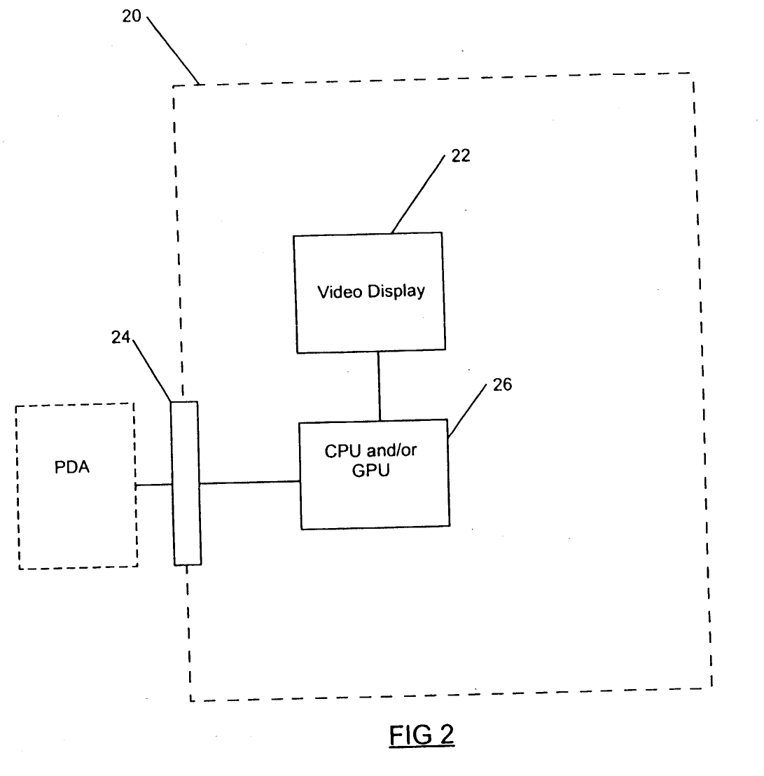

The present invention may also be embodied as a display device to increase the processing power of a PDA. The PDA allows increased portability over a desktop or laptop computer at the expense of processing capability. The present invention overcomes this disadvantage by coupling the PDA to a display device that augments its computational and graphics processing abilities. A block diagram representation of this device 20 is shown in FIG. 2.

This embodiment consists of a video display 22 with a connector 24 configured for electronically coupling to the PDA. The video display 22 may be a CRT monitor, an LCD display, touch screen or any other comparable viewing screen known to those skilled in the art. The connector 24 may be an interconnect module 25, designed to be removable from the video display. This configuration would allow the user the ability purchase an interconnect module 25 that would correspond and interface with the correct PDA model owned. The device further contains a processor 26 configured to receive and augment output from the PDA, thus increasing its processing capability. The processor might be a CPU, a GPU, or both. In the case of the CPU, the data processing capabilities of the PDA would be augmented. For the GPU, the graphics resolution and speed of the PDA would be enhanced. This increased level of processing power would enable the PDA to accomplish processing tasks similar to those of desktop computers.

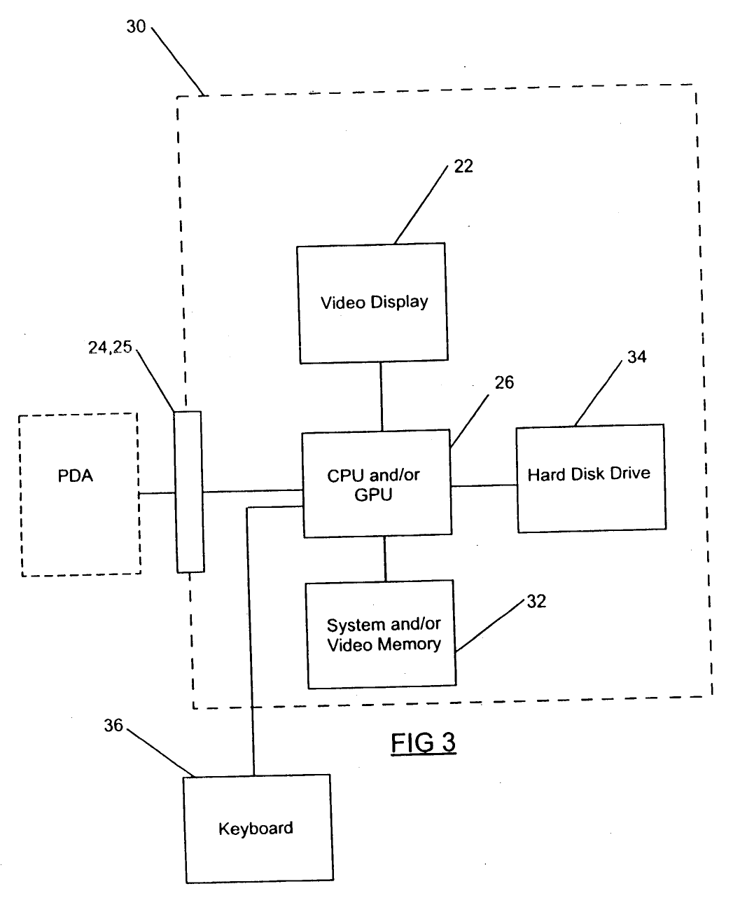

Another embodiment 30 (FIG. 3) of the invention might include additional memory 32 coupled to the CPU or to the GPU to further augment output of the PDA. Additionally, a hard disk drive 34 may be added to the device to allow the storage of data and software exclusive to the function of the core operations system when connected to the device, thus reserving the PDA memory storage for data key to the user. A keyboard 36 or dointing device such as a touch pad may be removeably coupled to the processor to allow a user to more easily interact with the display device. Examples of the type of coupling might include Universal Serial Bus (USB), serial connection, infrared or Radio Frequency (RF) or any other coupling connection known to those skilled in the art.

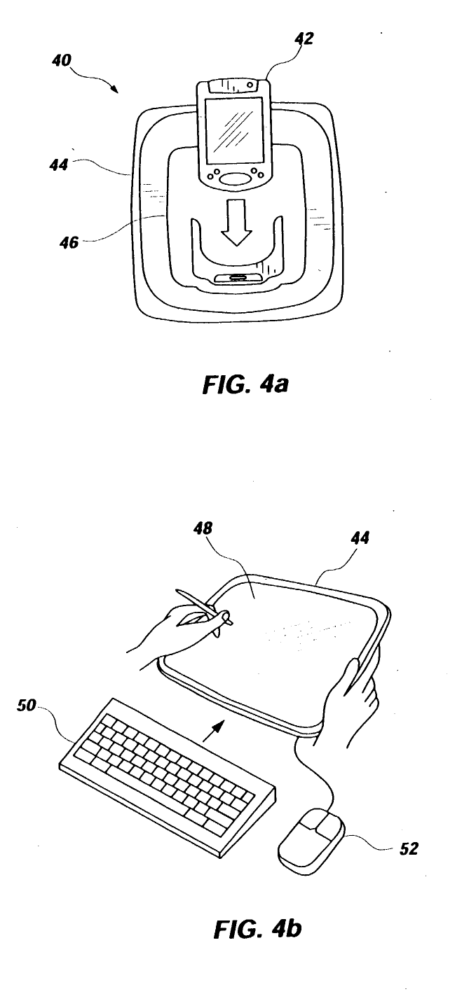

As shown in FIGS. 4a & 4b the present invention may also be embodied as a tablet system 40 for maintaining computational operating continuity for a user irrespective of the user's location that allows a change in processing power to meet changing computational needs. The tablet system 40 may comprise a PDA 42 configured with processing power and memory capacity for autonomous use as a core operations system, as well as in coupled combination with a tablet display device and alternatively, with a desktop display device. The PDA can be any of the set of small handheld computers, examples of which are the Palm devices, iPAQs, PocketPCs, and PDA/Cellular Phone combination devices. The tablet system further includes a tablet display device 44 for augmenting the processing power of the PDA 42 including means for attachment to the PDA 42.

The means for attachment to the PDA 42 is an interconnect module 46 configured to removably interconnect with the tablet display device 44 and configured to removably interconnect with the PDA 42. Subsequently, the interconnect module 46 electronically couples the PDA 42 to the tablet display device 44. Because a given interconnect module 46 is configured to couple with a specific model of PDA 42, a user may use various types of PDAs with the same tablet display device 44 by purchasing the corresponding interconnect module 46.

Additional elements of this embodiment may include various types of input devices to allow the user to interact with the tablet system 40, such as a touch screen 48, a keyboard 50, or a mouse 52.

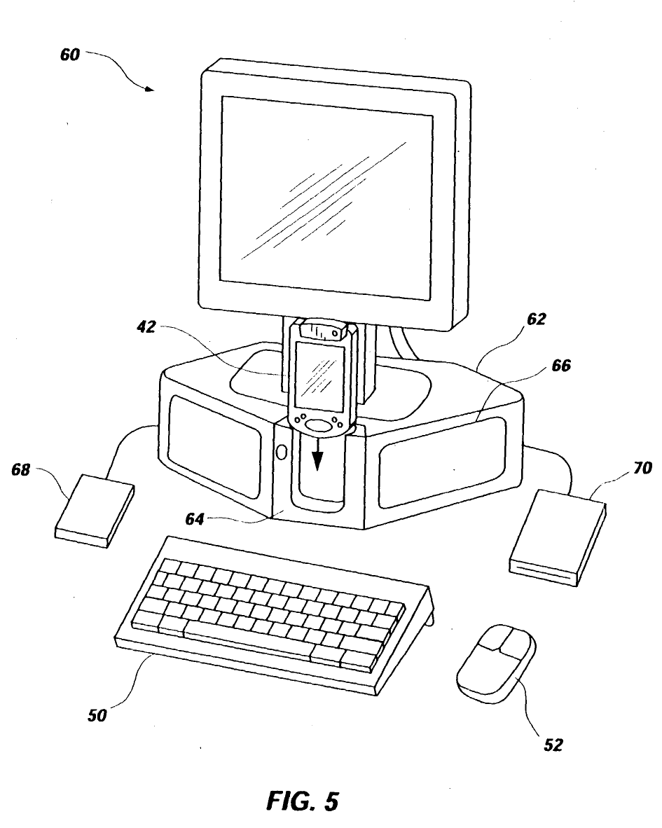

As shown in FIG. 5, the present invention may also be embodied as a desktop system 60 for maintaining computational operating continuity for a user irrespective of the user's location that allows a change in processing power to meet changing computational needs. The desktop system 60 may comprise a PDA 42 configured with processing power and memory capacity for autonomous use as a core operations system, as well as in coupled combination with a tablet display device and alternatively, with a desktop display device. The PDA can be any of the set of small handheld computers, examples of which are the Palm devices, iPAQs, PocketPCs, and PDA/Cellular Phone combination devices. The desktop system 60 further includes desktop display device 62 for augmenting the processing power of the PDA 42 including means for attachment to the PDA 42.

The means for attachment to the PDA 42 is an interconnect module 64 configured to removably interconnect with the desktop display device 62 and configured to removably interconnect with the PDA 42. Subsequently, the interconnect module 64 electronically couples the PDA 42 to the desktop display device 62. Because a given interconnect module 62 is configured to couple with a specific model of PDA 42, a user may use various types of PDAs with the same desktop display device 62 by purchasing the corresponding interconnect module 64.

Additional elements of this embodiment may include various types of input devices to allow the user to interact with the desktop system 60, such as a keyboard 50, or a mouse 52. At least one speaker 66 may be coupled to the desktop display device to allow a user to receive audio signals from the desktop system 60. Additionally, a hard disk drive 68 coupled to the desktop display device 62 may be used to increase the storage capacity of the PDA 42 while docked to the desktop display device 62. The hard disk drive 68 may be internal to the desktop display device 62 or external. In the external case, the hard disk drive 68 may be coupled to the desktop display device 62 by means of an IDE, SCSI, USB, Firewire, or any other type of connection known to be useful to one skilled in the art. A disk drive 70 may also be coupled to the desktop display device 62. This disk drive 70 may be a CDROM, CDRW, DVDROM, DVDRW, or any other useful drive known to one skilled in the art. Similar to the hard disk drive 68, the disk drive 70 may be internal to the desktop display device 62 or external.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims.

What is claimed is:

1. A method for maintaining computational operating continuity irrespective of a user's location that allows a change in processing power to meet changing computational needs, comprising the steps of:
a) providing a core operations system in a personal digital assistant;
b) manipulating the core operations system using the personal digital assistant when the user desires to perform computational tasks in physical locations where the use of a desktop computer is cumbersome;
c) alternatively coupling the personal digital assistant to a tablet display device augmenting processing power of the personal digital assistant for manipulating the core operations system when mobility is desired by the user and processing or display requirements exceed the capability of the personal digital assistant; and
d) alternatively coupling the personal digital assistant to a desktop display device to augment the processing power of the personal digital assistant for operation when mobility is unnecessary and processing or display requirements exceed the processing capability of the personal digital assistant.

2. A display device to increase processing power of a personal digital assistant, comprising:
a) a video display;
b) a connector coupled to the video display and configured for electronically coupling to the personal digital assistant;
c) a processor within the video display configured for receiving output from the personal digital assistant and for augmenting the output with greater processing capability for delivery to the video display.

3. A display device as in claim 2, wherein the processor is a graphics processing unit.

4. A display device as in claim 2, wherein the processor is a central processing unit.

5. A display device as in claim 2, wherein the video display further comprises random access memory coupled to the processor.

6. A display device as in claim 2, further comprising a keyboard removably coupled to the processor to allow a user to interact with the display device.

7. A display device as in claim 2, further comprising a hard disk drive coupled to the processor for increasing the storage capacity of the personal digital assistant.

8. A display device as in claim 2, wherein the connector is an interconnect module that is removably coupled to the video display.

9. A tablet system for maintaining computational operating continuity for a user irrespective of the user's location that allows a change in processing power to meet changing computational needs, said tablet system comprising:
a) a personal digital assistant configured with processing power and memory capacity for autonomous use as a core operations system, as well as in coupled combination with a tablet display device and alternatively, with a desktop display device; and
b) a tablet display device for augmenting the processing power of the personal digital assistant including means for attachment to the personal digital assistant.

10. A tablet system as in claim 9, wherein the means for attachment to the personal digital assistant is an interconnect module configured to removably interconnect with the tablet display device and configured to removably interconnect with the personal digital assistant, such that the personal digital assistant is electronically coupled to the tablet display device.

11. A tablet system as in claim 9, wherein the tablet display device accepts input by means of a touch screen.

12. A tablet system as in claim 9, further comprising a keyboard removably coupled to the tablet display device to allow a user to interact with the tablet system.

13. A tablet system as in claim 9, further comprising a mouse removably coupled to the tablet display device to allow a user to interact with the tablet system.

14. A tablet system as in claim 9, wherein the personal digital assistant is a personal digital assistant, a cellular phone or cellular phone/PDA combination device.

15. A desktop system for maintaining computational operating continuity for a user irrespective of the user's location that allows a change in processing power to meet changing computational needs, said desktop system comprising:
a) a personal digital assistant configured with processing power and memory capacity for autonomous use as a core operations system, as well as in coupled combination with a tablet display device and alternatively, with a desktop display device; and
b) a desktop display device for augmenting the processing power of the personal digital assistant including means for attachment to the personal digital assistant.

16. A desktop system as in claim 15, wherein the means for attachment to the personal digital assistant is an interconnect module configured to removably interconnect with the desktop display device and configured to removably interconnect with the personal digital assistant, such that the personal digital assistant is electronically coupled to the desktop display device.

17. A desktop system as in claim 15, further comprising a keyboard removably coupled to the desktop display device to allow a user to interact with the desktop system.

18. A desktop system as in claim 15, further comprising a mouse removably coupled to the desktop display device to allow a user to interact with the desktop system.

19. A desktop system as in claim 15, further comprising at least one speaker coupled to the desktop display device to allow a user to receive audio signals from the desktop system.

20. A desktop system as in claim 15, further comprising a hard disk drive coupled to the desktop display device for increasing the storage capacity of the personal digital assistant.

21. A desktop system as in claim 15, further comprising a disk drive coupled to the desktop display device.

22. A desktop system as in claim 15, wherein the personal digital assistant is a personal digital assistant and cellular phone combination device.
